(19) United States
(12) Patent Application Publication
(10) Pub. No.: US 2025/0264840 A1
(43) Pub. Date: Aug. 21, 2025

(54) SHEET CONVEYANCE APPARATUS, IMAGE READING APPARATUS, AND IMAGE FORMING APPARATUS

(71) Applicant: CANON KABUSHIKI KAISHA, Tokyo (JP)

(72) Inventor: SHOGO YAMASAKI, Chiba (JP)

(21) Appl. No.: 19/054,248

(22) Filed: Feb. 14, 2025

(30) Foreign Application Priority Data
Feb. 16, 2024 (JP) 2024-022450

(51) Int. Cl. G03G 15/00; G03G 21/16; H04N 1/00

(52) U.S. Cl. CPC G03G 15/6529; G03G 21/168; H04N 1/00604; H04N 1/0062; G03G 2221/1654

(57) ABSTRACT

A sheet conveyance apparatus includes a stacking tray having a sheet stacking surface, a feeding roller configured to feed the sheet in a feeding direction, and a first side regulating member disposed in the stacking tray to be movable in a width direction and configured to regulate a position of one end of the sheet in the width direction, the first side regulating member having a first regulating surface to contact with the one end of the sheet, and a first supporting surface configured to support the sheet, wherein the first side regulating member has, at a downstream side end of the first supporting surface in the feeding direction, a first scooping portion that is configured to scoop the sheet onto the first supporting surface when the first side regulating member moves and that extends from the first supporting surface to below the sheet stacking surface.

### BACKGROUND

### Field

The present disclosure relates to a sheet conveyance apparatus that conveys a sheet, an image reading apparatus including the sheet conveyance apparatus, and an image forming apparatus including the sheet conveyance apparatus.

### Description of the Related Art

Some typically known image reading apparatuses to be mounted on image forming apparatuses, such as copy machines, include an auto document feeder (hereinafter referred to an ADF) that conveys a document placed on a document tray one sheet by one sheet. In such an image reading apparatus, a document to be conveyed by the ADF is discharged to a discharge tray after an image is read by a reading unit.

A document tray of the ADF and/or a manual feed tray of the image forming apparatus includes a pair of side regulating members for preventing a sheet from being skewed when the sheet is fed. When setting a sheet on the document tray or the manual feed tray, a user moves the pair of side regulating members to fit a width of the sheet. United States Patent Application Publication No. 2022/0089388 discusses a side regulating member provided with a scooping portion to prevent a sheet from entering below the side regulating member when the user moves the side regulating member.

There has been a growing demand for ADFs and image forming apparatuses to support various sheet sizes, particularly for feeding small-sized sheets, such as business cards and receipts. Such small-sized sheets have a short length in a feeding direction, so that the set sheet may be out of reach of a scooping portion of a side regulating member. In such a case, there is a possibility that the sheet enters below the side regulating member, which can damage the sheet.

### SUMMARY

The present disclosure is directed to a technique of enabling a side regulating member to smoothly scoop a small-sized sheet.

According to some embodiments, a sheet conveyance apparatus includes a stacking tray having a sheet stacking surface on which a sheet is stacked, a feeding roller configured to feed the sheet stacked on the stacking tray in a feeding direction, and a first side regulating member disposed in the stacking tray to be movable in a width direction orthogonal to the feeding direction and configured to regulate a position of one end of the sheet stacked on the stacking tray in the width direction, the first side regulating member having a first regulating surface to be brought into contact with the one end of the sheet in the width direction, and a first supporting surface configured to, together with the sheet stacking surface, support the sheet, wherein the first side regulating member has, at a downstream side end of the first supporting surface in the feeding direction, a first scooping portion that is configured to scoop the sheet onto the first supporting surface when the first side regulating member moves and that extends from the first supporting surface to below the sheet stacking surface.

Further features of the present disclosure will become apparent from the following description of exemplary embodiments with reference to the attached drawings.

### BRIEF DESCRIPTION OF THE DRAWINGS

FIG. 1 is a sectional view schematically illustrating an image forming apparatus.

FIG. 2 is a sectional view schematically illustrating an image reading apparatus.

FIG. 3 is a perspective view of an auto document feeder (ADF).

FIG. 4 is a perspective view of the ADF.

FIG. 5 is a view illustrating a configuration of a document tray.

FIG. 6 is a view illustrating a configuration of an upper cover member of the document tray.

FIG. 7 is a plan view illustrating an interlocking mechanism of a side regulating portion.

FIG. 8 is a top view of the document tray.

FIG. 9 is a front view of the document tray.

FIG. 10 is a top view of the document tray.

FIG. 11 is an enlarged front view of the document tray.

FIG. 12 is an enlarged front view of the document tray.

FIG. 13 is a perspective view of the ADF.

FIG. 14 is a perspective view of the ADF.

FIG. 15 is a view illustrating a configuration of a document tray.

FIG. 16 is a top view of the document tray.

### DESCRIPTION OF THE EMBODIMENTS

Various exemplary embodiments, features, and aspects of a sheet feeding apparatus, an image reading apparatus, and an image forming apparatus according to the present disclosure will be described below with reference to the accompanying drawings. Dimensions, materials, shapes, and relative arrangement of the components and the like described in the following exemplary embodiments are not intended to limit a scope of application of the present technology unless specifically described.

### Image Forming Apparatus

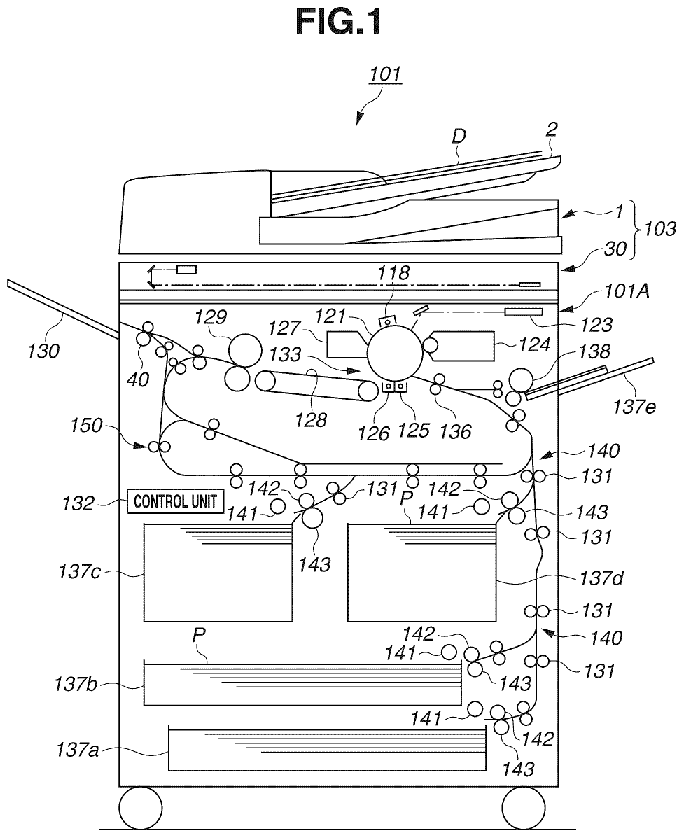

Initially, a schematic configuration of an image forming apparatus 101 is described with reference to FIG. 1. In the following description, a position at which a user performs an operation on an operation unit to perform various types of input/setting to the image forming apparatus 101 is referred to as a “front side” of the image forming apparatus 101, and a back surface side of the image forming apparatus 101 is referred to as a “back side”. Specifically, FIG. 1 illustrates an internal configuration of the image forming apparatus 101 when viewed from the front side. The image forming apparatus 101 includes a printer main body 101A and an image reading apparatus 103, as illustrated in FIG. 1. The image reading apparatus 103 disposed above the printer main body 101A includes a reader 30 and an auto document feeder (ADF) 1, which will be described in detail below, and optically scans a document and reads image information. Examples of the document include paper, such as a paper sheet or an envelope, a plastic film such as a sheet for an overhead projector (OHP), and a cloth sheet. The image information converted into an electric signal by the image reading apparatus 103 is transferred to a control unit 132 included in the printer main body 101A.

The printer main body 101A includes an image forming unit 133 capable of forming an image on a sheet P serving as a recording medium, and a sheet feeding unit 140 that feeds the sheet P to the image forming unit 133. The sheet feeding unit 140 includes sheet accommodation units 137a, 137b, 137c, and 137d that are capable of accommodating sheets in mutually different sizes. Sheets accommodated in each sheet accommodation unit are sent out by a pickup roller 141, separated from the other sheets one sheet by one sheet by a feeding roller 142 and a retard roller 143, and transferred to the corresponding conveyance roller pair 131. A sheet P is sequentially transferred to a plurality of conveyance roller pairs 131 arranged along a sheet conveyance path, and so that the sheet P is conveyed to a registration roller pair 136.

The sheet P placed on a manual feed tray 137e by a user is fed to the inside of the printer main body 101A by a feeding roller 138, and conveyed to the registration roller pair 136. The registration roller pair 136 stops a leading end of the sheet P to correct skew, and also resumes conveyance of the sheet P in step with the progress of an image formation operation, which is a toner image formation process to be performed by the image forming unit 133.

The image forming unit 133 that forms an image on the sheet P is an electrophotographic image forming unit including a photosensitive drum 121 serving as a photosensitive body. The photosensitive drum 121 is rotatable along a conveyance direction of the sheet P. A charger 118, an exposure device 123, a developing device 124, a transfer charger 125, a separation charger 126, and a cleaner 127 are disposed around the photosensitive drum 121. The charger 118 uniformly charges the surface of the photosensitive drum 121. The exposure device 123 exposes the photosensitive drum 121 based on image information input from the image reading apparatus 103 or the like, and forms an electrostatic latent image on the photosensitive drum 121.

The developing device 124 contains a two-component developer including toner and carriers, and supplies charged toner to the photosensitive drum 121 to develop the electrostatic latent image into a toner image. The toner image borne by the photosensitive drum 121 is transferred onto the sheet P, which has been conveyed by the registration roller pair 136, by a bias electric field formed by the transfer charger 125. The sheet P serving as a recording medium onto which the toner image has been transferred is separated from the photosensitive drum 121 by a bias electric field formed by the separation charger 126, and conveyed toward a fixing unit 129 by a pre-fixing conveyance unit 128. A sticking substance, such as transfer residual toner, that has not been transferred to the sheet P and that has been left in the photosensitive drum 121 is removed by the cleaner 127, and the photosensitive drum 121 prepares for a subsequent image formation operation.

The sheet P that has been conveyed to the fixing unit 129 is heated while being nipped and pressed by a roller pair, and subjected to fixing of an image by melting and solidification of toner. In a case where the output of the image is completed, the sheet P that has been subjected to the fixing of the image is discharged via a discharge roller pair 40 to a discharge tray 130 that protrudes toward the outside of the printer main body 101A. In a case where an image is formed on a back surface of the sheet P in double-sided printing, the front surface and back surface of the sheet P that has passed through the fixing unit 129 are reversed by a reverse unit 139, and the sheet P is conveyed to the registration roller pair 136 by a double-sided conveyance unit 150. The sheet P on which the image is formed again by the image forming unit 133 is discharged to the discharge tray 130. In this manner, the image forming unit 133 is capable of forming an image on a sheet P based on an image of a document D read by a first reading unit 151 and a second reading unit 201, which will be described below. In addition to the above-mentioned electrophotographic method, the image forming unit 133 serving as an image forming means may employ other methods such as an inkjet method.

### Image Reading Apparatus

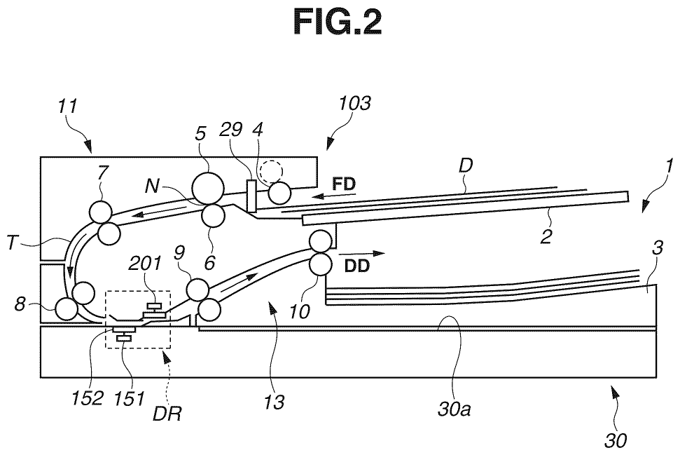

Subsequently, a configuration of the image reading apparatus 103 is now described with reference to FIG. 2. FIG. 2 is a sectional view schematically illustrating the image reading apparatus 103. As illustrated in FIG. 2, the image reading apparatus 103 includes the reader 30 as a reading unit that reads a document image, and the ADF 1 as a sheet conveyance apparatus. The ADF 1 includes a base unit 13, an opening/closing cover 11 that is supported by the base unit 13 to be openable and closable, a document tray 2 on which the document D is to be stacked, and a discharge tray 3 disposed blow the document tray 2. The image reading apparatus 103 includes the first reading unit 151 disposed in the reader 30 and the second reading unit 201 disposed in the ADF 1. The first reading unit 151 and the second reading unit 201 are examples of a reading means in the present exemplary embodiment.

The first reading unit 151 reads an image on a first surface of the document D. The second reading unit 201 reads an image on a second surface of the document D. The second surface is on the opposite side of the first surface. The first surface in the present exemplary embodiment is the bottom side surface of the document D in a double-sided reading unit DR, and the second surface is the top side surface of the document D in the double-sided reading unit DR. The first reading unit 151 and the second reading unit 201 constitute the double-sided reading unit DR capable of simultaneously reading both surfaces of the document D conveyed by the ADF 1. However, the double-sided reading unit DR does not necessarily constantly execute simultaneous reading of both surfaces and is capable of reading only one surface.

The first reading unit 151 and the second reading unit 201 each include a contact image sensor (hereinafter referred to as a CIS), which is a scanning device of an equal-magnification optical system. The first reading unit 151 and the second reading unit 201 each include a light source including an array of light emitting diodes (LEDs) arrayed in a main scanning direction that is orthogonal to a conveyance direction of the document D, and a plurality of light receiving elements also arrayed in the main scanning direction. Light that has been emitted from the array of LEDs and reflected by the document D forms an image on each light receiving element via a lens, and is photoelectrically converted by the light receiving element.

The reader 30 is fixed to an upper surface of the printer main body 101A (refer to FIG. 1). A transparent document positioning plate 30a is disposed on the upper surface of the reader 30. The first reading unit 151 is supported by a carriage (not illustrated) that is movable in a left-and-right direction in FIG. 2, and is movable from a predetermined position in the double-sided reading unit DR for the entire length of the document positioning plate 30a along the document positioning plate 30a.

The ADF 1 is provided to be openable and closable in an up-and-down direction with respect to the reader 30 with a hinge mechanism (not illustrated) disposed on the rear side in FIG. 2. The document tray 2 serving as a sheet stacking unit supports a document placed by the user. A document conveyance path T that curves in a substantially U-shape is formed in the ADF 1. The ADF 1 conveys the document D placed on the document tray 2 to the double-sided reading unit DR via the document conveyance path T. The user opens the opening/closing cover 11 with respect to the base unit 13, and can thereby expose part of the document conveyance path T.

Subsequently, a configuration of the ADF 1 for conveying the document D is described in detail. The ADF 1 includes a pickup roller 4, a conveyance roller 5, a separation roller 6, a registration roller pair 7, conveyance roller pairs 8 and 9, and a discharge roller pair 10 in this order along a document conveyance direction (indicated by an arrow in FIG. 2). The ADF 1 includes a shutter 29, and the document D is set on the document tray 2 in a state of abutting against the shutter 29. The shutter 29 serving as an abutting portion is configured to regulate the document D from moving in a feeding direction FD before the start of feeding, and permit the document D to move in the feeding direction FD after the start of feeding. The pickup roller 4 serving as a feeding means is movable in the up-and-down direction with respect to the upper surface of the document tray 2, and comes into contact with the document D on the document tray 2 to feed the document D in the feeding direction FD. The conveyance roller 5 conveys the document D received from the pickup roller 4 toward a downstream side in the feeding direction FD. The separation roller 6 is brought into pressure contact with the conveyance roller 5 to form a separation nip N as a separation portion between the separation roller 6 and the conveyance roller 5, and separates the document D conveyed by the conveyance roller 5 into individual sheets. In the present exemplary embodiment, the conveyance roller 5 and the separation roller 6 form the separation nip N, but a configuration is not limited thereto. For example, a retard roller to which driving for reverse rotation is input via a torque limiter, a separation pad, or the like may be applied instead of the separation roller 6.

A feed shaft which is a rotary shaft of the conveyance roller 5 is rotatably supported by the opening/closing cover 11, and the pickup roller 4 is supported by the opening/closing cover 11 to be pivotable with respect to the feed shaft via a pickup arm, which is not illustrated. One roller of the registration roller pair 7 is also rotatably supported by the opening/closing cover 11.

The registration roller pair 7, in a rotation stopped state, receives a downstream side end of the document D, which is conveyed by the conveyance roller 5, in the conveyance direction (hereinafter, such a downstream side end is referred to as a leading end), and flexes the document D to correct skew of the document D. The registration roller pair 7 conveys the document D having been subjected to the skew correction via a bend portion of the document conveyance path T, and transfers the document D to a conveyance roller pair 8. The conveyance roller pair 8 sends the document D to the double-sided reading unit DR and transfers the document D to a conveyance roller pair 9 on the downstream side. At this time, an image on the document D is read by the first reading unit 151 and the second reading unit 201.

The conveyance roller pair 9 transfers the document D that has passed the double-sided reading unit DR to the discharge roller pair 10. The discharge roller pair 10 which is a discharge means discharges the document D in a discharge direction DD. The document D discharged by the discharge roller pair 10 is stacked on the discharge tray 3 as a discharge stacking unit.

The image reading apparatus 103 having such a configuration reads image information from the document D using a streaming reading mode or a fixed reading mode. In the streaming reading mode, the image reading apparatus 103 scans a document image while feeding the document D with the ADF 1. In the fixed reading mode, the image reading apparatus 103 scans the document placed on the document positioning plate 30a. In a case where the document D placed on the document tray 2 is detected, or in a case where the user explicitly instructs execution of the streaming reading mode via an operation panel or the like on the printer main body 101A, the streaming reading mode is selected. In this case, the ADF 1 feeds the document D toward the double-sided reading unit DR one sheet by one sheet in a state where the first reading unit 151 is at a predetermined position on the double-sided reading unit DR. In a case of the double-sided simultaneous reading, both the first reading unit 151 and the second reading unit 201 irradiate the document D with a scanning beam to scan the document D. In a case of the one-sided reading, either the first reading unit 151 or the second reading unit 201 irradiates the document D with a scanning beam to scan the document D. The image information converted into an electric signal by the light receiving elements is transferred to the control unit 132 in the printer main body 101A.

In contrast, in a case where the document D placed on the document positioning plate 30a is detected by the image reading apparatus 103, or in a case where the user explicitly instructs execution of the fixed reading mode via the operation panel or the like on the printer main body 101A, the fixed reading mode is selected. In this case, the first reading unit 151 irradiates the document D placed on the document positioning plate 30a with light to scan the document D while moving along the document positioning plate 30a. The image information converted into an electric signal by the light receiving element in the first reading unit 151 is transferred to the control unit 132 in the printer main body 101A.

### Document Tray

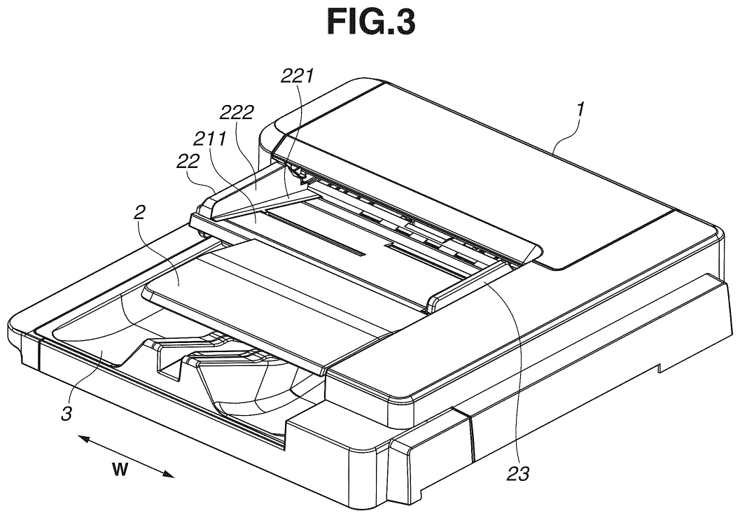

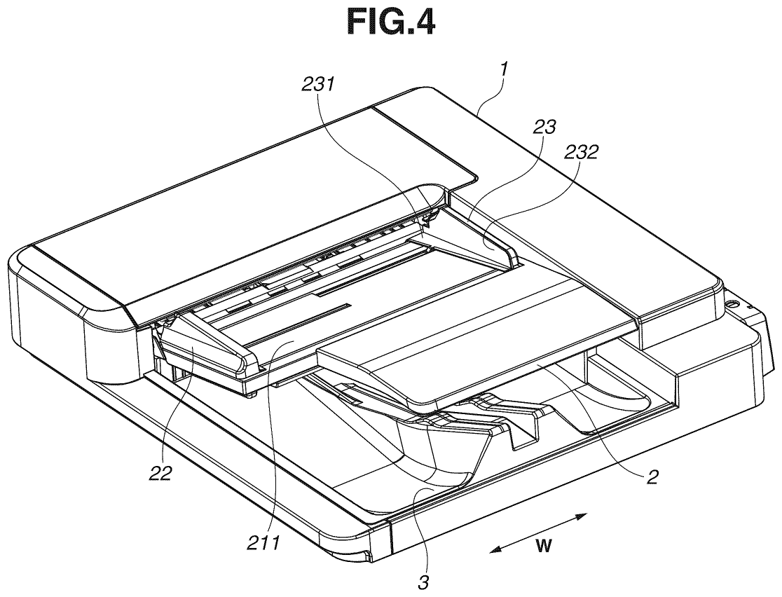

Subsequently, the configuration of the document tray 2 is described with reference to FIGS. 3 to 7. FIGS. 3 and 4 are perspective views of the ADF 1. The document tray 2 includes a document stacking surface 211 as a sheet stacking surface for supporting the document, and a first side regulating member 22 and a second side regulating member 23 that regulate respective positions of the document in a width direction W. The first side regulating member 22 regulates a position of a front side end of the document (a position of one end). The second side regulating member 23 regulates a position of a back side end of the document (a position of the other end). The document stacking surface 211 is formed on an upper cover member 21 serving as a main body of the document tray 2 and is used for supporting the document. The upper cover member 21 will be described below. As illustrated in FIG. 2, the document stacking surface 211 is slightly inclined so that the document stacking surface 211 lowers toward the downstream side in the feeding direction FD. The first side regulating member 22 and the second side regulating member 23 are disposed to be movable in the width direction W that is perpendicular to the feeding direction FD. The first side regulating member 22 and the second side regulating member 23 are configured to be movable in mutually opposite directions in coordination with each other via an interlocking mechanism, which will be described below. For example, when the first side regulating member 22 moves to the back side of the image reading apparatus 103, the second side regulating member 23 moves to the front side of the image reading apparatus 103 in conjunction with the movement of the first side regulating member 22.

The first side regulating member 22 includes a first supporting surface 221 formed along the document stacking surface 211 and a first regulating surface 222 formed to be substantially perpendicular to the document stacking surface 211 and the first supporting surface 221. The first supporting surface 221 is a surface that, together with the document stacking surface 211, supports the document, and slides on the document stacking surface 211. The first supporting surface 221 is a surface that extends in the feeding direction FD and the width direction W. The first regulating surface 222 is integrally formed to stand up from an outermost side of the first supporting surface 221 in the width direction W, and is a surface against which the front side end (edge) of the document is abutted. Similarly, the second side regulating member 23 includes a second supporting surface 231 formed along the document stacking surface 211 and a second regulating surface 232 formed to be substantially perpendicular to the document stacking surface 211 and the second supporting surface 231. The second supporting surface 231 is a surface that, together with the document stacking surface 211, supports the document, and slides on the document stacking surface 211. The second regulating surface 232 is integrally formed to stand up from an outermost side of the second supporting surface 231 in the width direction W, and is a surface against which the back side end (edge) of the document is abutted.

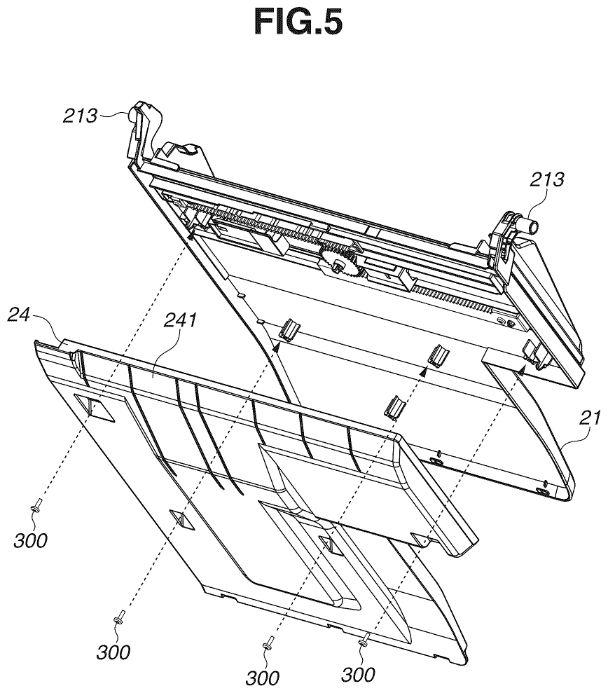

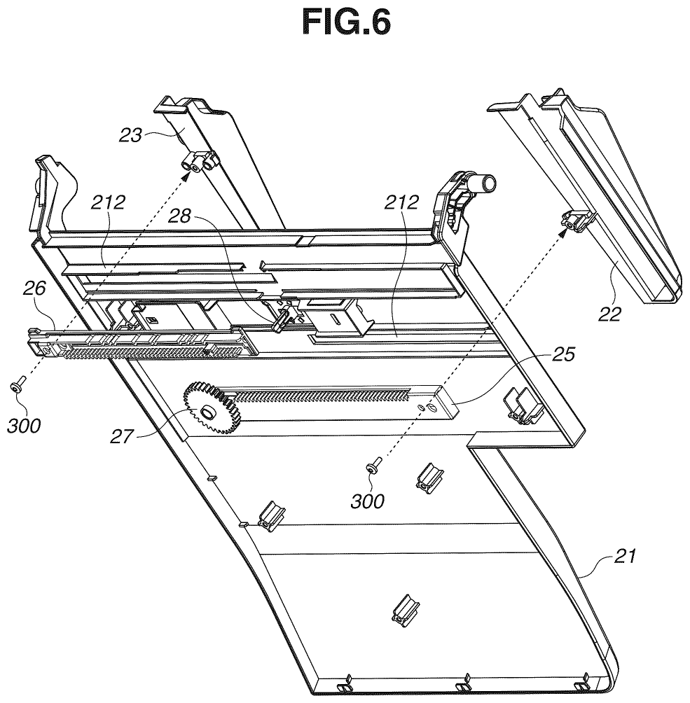

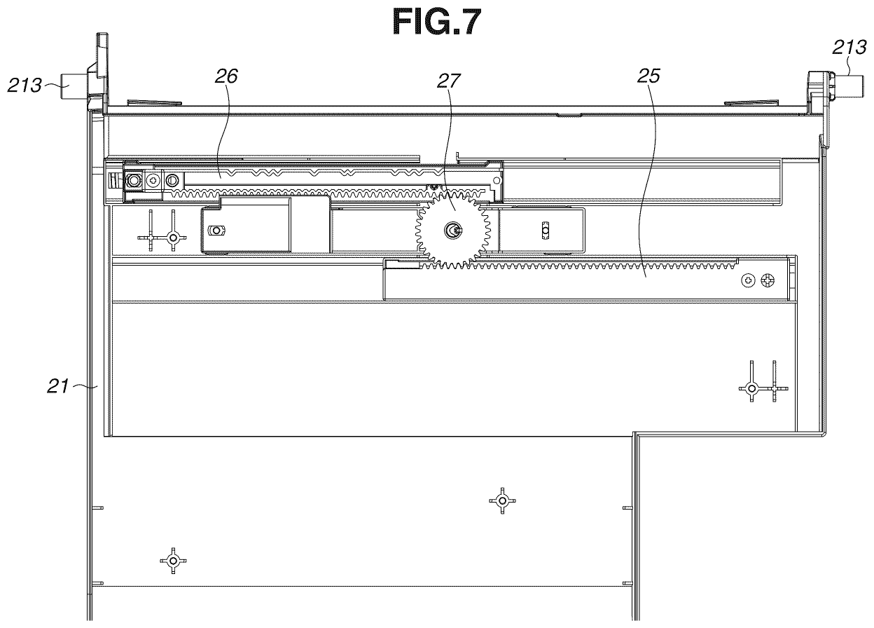

FIG. 5 is an exploded perspective view of the document tray 2. FIG. 6 is a perspective view of the upper cover member 21 serving as the main body of the document tray 2 when viewed from below. FIG. 7 is a plan view of the upper cover member 21 when viewed from the back side (below) and is a view illustrating the interlocking mechanism. The document tray 2 includes the upper cover member 21 and a lower cover member 24. The upper cover member 21 includes the above-mentioned document stacking surface 211. The lower cover member 24 covers the upper cover member 21 from below. The lower cover member 24 is fixed to the upper cover member 21 with a plurality of screws 300. The lower cover member 24 faces the discharge tray 3, and includes a discharge guide surface 241 that guides the document discharged by the discharge roller pair 10. On the discharge guide surface 241, a plurality of ribs extending along the discharge direction DD is formed.

As the interlocking mechanism for moving the first side regulating member 22 and the second side regulating member 23 in conjunction with each other, a first rack portion 25, a second rack portion 26, and a pinion gear 27 are attached to the upper cover member 21. A plurality of teeth is formed in a straight line on each of the first rack portion 25 and the second rack portion 26. Two slits 212 extending in the width direction W are formed in the upper cover member 21. The first rack portion 25 is fixed to the first side regulating member 22 with a screw 300 via the slit 212, and the first side regulating member 22 and the first rack portion 25 are disposed to sandwich the upper cover member 21 (document stacking surface 211). Similarly, the second rack portion 26 is fixed to the second side regulating member 23 with a screw 300 via the slit 212, and the second side regulating member 23 and the second rack portion 26 are disposed to sandwich the upper cover member 21 (document stacking surface 211). A pinion gear supporting portion 28 is formed in the upper cover member 21, and the pinion gear 27 is engaged with the pinion gear supporting portion 28 in a rotatable manner. As illustrated in FIG. 7, the pinion gear 27 is provided to be engaged with both the first rack portion 25 and the second rack portion 26. With this configuration, the rotation of the pinion gear 27 at the time of movement of one of the first side regulating member 22 or the second side regulating member 23 enables the other one of the first side regulating member 22 and the second side regulating member 23 to move in the opposite direction in conjunction with the rotation.

Pivot shafts 213 are formed at the downstream side end of the upper cover member 21 in the feeding direction FD to protrude in the width direction W. Meanwhile, the base unit 13 has bearings (not illustrated) to which the pivot shafts 213 are fitted. The pivot shafts 213 being fitted to the respective bearings in the base unit 13 enables the upper cover member 21 to pivot about the pivot shafts 213 with respect to the base unit 13.

The document tray 2 is configured to be pivotable with respect to the base unit 13. This enables the user to retrieve the document discharged to the discharge tray 3 in a state where the document tray 2 is lifted upward.

### Document Scooping Shape

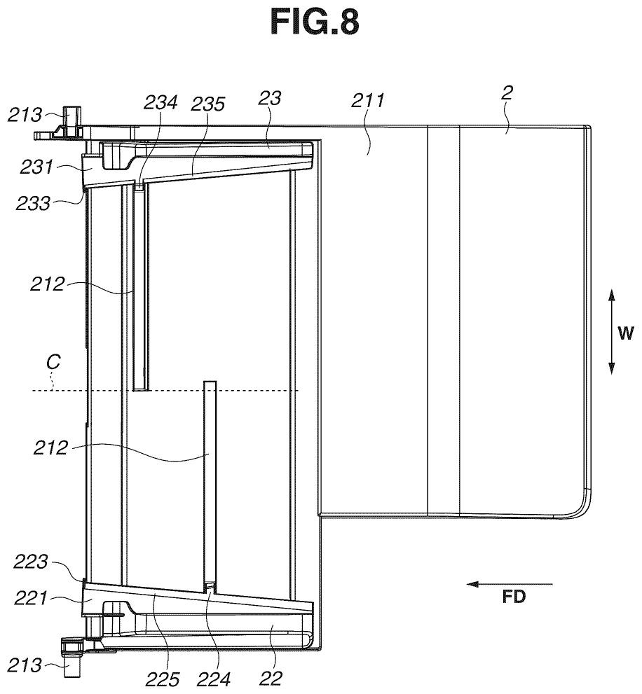

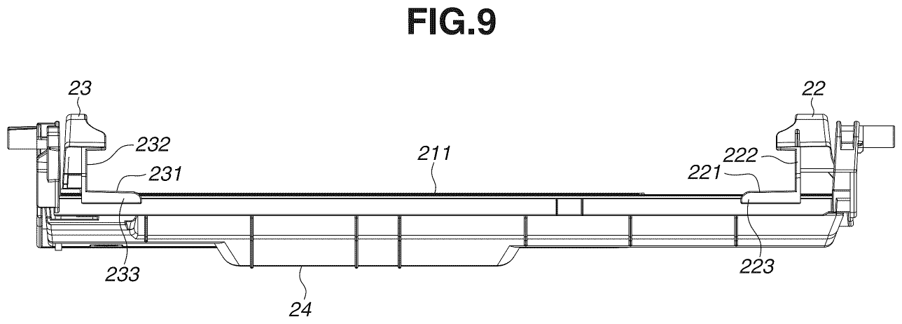

FIG. 8 is a top view of the document tray 2. FIG. 9 is a front view of the document tray 2 when viewed from the downstream side in the feeding direction FD. In the following description, the “inside (or inner, inward)” in the width direction W means the side closer to the center of conveyance C (refer to FIG. 8). The center of conveyance C mentioned here is a middle of the pickup roller 4, and is a middle position between the first regulating surface 222 and the second regulating surface 232. The first supporting surface 221 of the first side regulating member 22 includes a first scooping portion 223 at the downstream side end of the first supporting surface 221 in the feeding direction FD and at the inner end of the first supporting surface 221 in the width direction W. The second supporting surface 231 of the second side regulating member 23 includes a second scooping portion 233 at the downstream side end of the second supporting surface 231 in the feeding direction FD and at the inner end of the second supporting surface 231 in the width direction W. The first scooping portion 223 and the second scooping portion 233 are respectively formed at the most downstream side position (downstream side end) of the first supporting surface 221 and the most downstream side position (downstream side end) of the second supporting surface 231. The first scooping portion 223 and the second scooping portion 233 are inclined downward toward the inside in the width direction W, and are formed to extend below the document stacking surface 211. The first scooping portion 223 and the second scooping portion 233 are disposed to slide to the downstream side end of the document stacking surface 211 (upper cover member 21).

The first supporting surface 221 of the first side regulating member 22 includes a third scooping portion 224 upstream of the first scooping portion 223 in the feeding direction FD. The second supporting surface 231 of the second side regulating member 23 includes a fourth scooping portion 234 upstream the second scooping portion 233 in the feeding direction FD. The third scooping portion 224 is formed upstream the fourth scooping portion 234. The third scooping portion 224 and the fourth scooping portion 234 are inclined downward toward the inside in the width direction W, and are formed to extend below the document stacking surface 211, as in the first scooping portion 223 and the second scooping portion 233. The third scooping portion 224 and the fourth scooping portion 234 are fitted to the respective slits 212 formed in the document stacking surface 211 to be slidable inside the respective slits 212.

An end (outer edge) in the width direction W of the first supporting surface 221 of the first side regulating member 22 serves as a first inclined portion 225 (first inclined surface) having a shape that approaches the first regulating surface 222 as it extends upstream from the first scooping portion 223 in the feeding direction FD. An end (outer edge) in the width direction W of the second supporting surface 231 of the second side regulating member 23 serves as a second inclined portion 235 (second inclined surface) having a shape that approaches the second regulating surface 232 as it extends upstream from the second scooping portion 233 in the feeding direction FD. The first inclined portion 225 and the second inclined portion 235 are inclined downward toward the inside in the width direction W. Each of the first inclined portion 225 and the second inclined portion 235 has a shape that is inclined outward in the width direction W as it extends upstream in the feeding direction FD and is inclined downward to the inside in the width direction W. In other words, each of the first supporting surface 221 and the second supporting surface 231 has a shape with a length in the width direction W that becomes shorter as it extends upstream in the feeding direction FD. The first scooping portion 223 is formed at the most inner position of the first supporting surface 221 in the width direction W. The second scooping portion 233 is formed at the most inner position of the second supporting surface 231 in the width direction W.

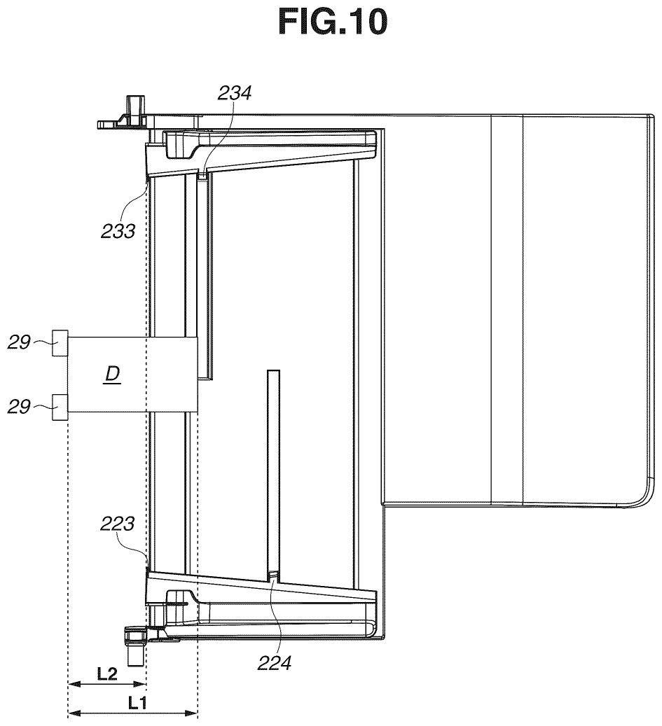

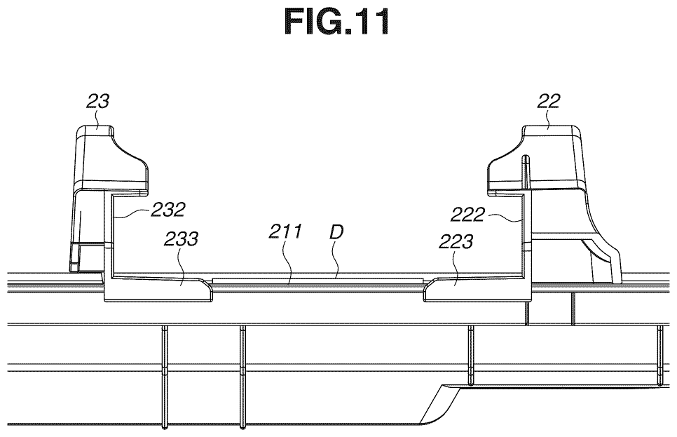

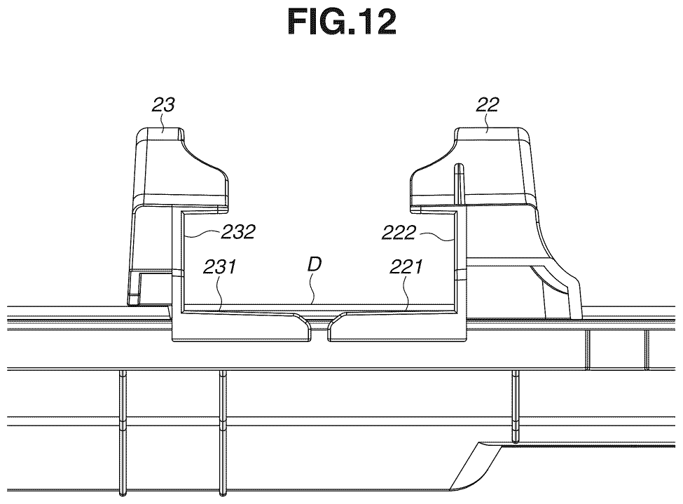

FIG. 10 is a top view of the document tray 2 in a state where the document D of a business card size is placed. The document D illustrated in FIG. 10 has a Japanese standard business card size (55 mm×91 mm), and is the smallest-sized document among documents conveyable by the ADF 1 according to the present exemplary embodiment. Here, the smallest-sized document conveyable by the ADF 1 refers to, for example, the smallest-sized document among supported sheets described in product specifications and the like. FIG. 11 is a front view of the document tray 2 in a state where the first side regulating member 22 and the second side regulating member 23 are moved to the inside in the width direction W, and the first scooping portion 223 and the second scooping portion 233 come into contact with the document D. FIG. 12 is a front view of the document tray 2 in a state where the first regulating surface 222 and the second regulating surface 232 come into contact with both ends of the document D in the width direction W.

As described above, the document D is set in the document tray 2 in a state where the document D abuts against the shutter 29. When the user moves the first regulating surface 222 and the second regulating surface 232 to the inside to fit the width of the document D, the first scooping portion 223 and the second scooping portion 233 first come into contact with the corresponding ends of the document D as illustrated in FIG. 11. At this time, since the first scooping portion 223 and the second scooping portion 233 extend to the lower side of the document stacking surface 211, the respective ends of the document D are scooped by the first scooping portion 223 and the second scooping portion 233 from below. Hence, the document D is guided onto the first supporting surface 221 and the second supporting surface 231 without the ends of the document D getting caught. Furthermore, when the first side regulating member 22 and the second side regulating member 23 are brought close to each other, the document D is scooped onto the first supporting surface 221 and the second supporting surface 231 by the first inclined portion 225 and the second inclined portion 235 continuously from the leading end to the trailing end of the document D. As illustrated in FIG. 12, the first regulating surface 222 and the second regulating surface 232 abut against the respective ends of the document D in the width direction W, so that the position of the document D is regulated.

The smallest-sized document conveyable by the ADF 1 according to the present exemplary embodiment is the Japanese standard business card size (55 mm×91 mm). Here, a distance L1 from the shutter 29 to the trailing end of the document is 91 millimeters (mm). In order to cause the first scooping portion 223 and the second scooping portion 233 to scoop a document, a distance L2 from the shutter 29 to each of the first scooping portion 223 and the second scooping portion 233 desirably satisfies L2<L1 (91 mm in the present exemplary embodiment). That is, the distance L2 from the shutter 29 to each of the first scooping portion 223 and the second scooping portion 233 is desirably shorter than a length of the smallest-sized sheet conveyable by the image reading apparatus 103.

As described above, the first scooping portion 223 is formed on the first supporting surface 221 of the first side regulating member 22 at the downstream side end of the first supporting surface 221 in the feeding direction FD. The second scooping portion 233 is formed on the second supporting surface 231 of the second side regulating member 23 at the downstream side end of the second supporting surface 231 in the feeding direction FD. The first scooping portion 223 and the second scooping portion 233 are inclined downward toward the inside in the width direction W, and are formed to extend below the document stacking surface 211. Such a first scooping portion 223 and a second scooping portion 233 enable even the small-sized sheet such as a business card to be scooped onto the first supporting surface 221 and the second supporting surface 231 without getting caught. This configuration can prevent the document from entering under the first supporting surface 221 and the second supporting surface 231 and being damaged.

Each of the first supporting surface 221 and the second supporting surface 231 has a shape with the length in the width direction W that becomes shorter as it extends upstream in the feeding direction FD. Hence, the document D is scooped onto the first supporting surface 221 and the second supporting surface 231 continuously from the leading end to the trailing end of the document D by the first inclined portion 225 and the second inclined portion 235. This configuration can further prevent the document from getting caught on the first side regulating member 22 and the second side regulating member 23.

The third scooping portion 224 is formed on the first supporting surface 221 on the upstream side of the first scooping portion 223 in the feeding direction FD. The fourth scooping portion 234 is formed on the second supporting surface 231 on the upstream side of the second scooping portion 233 in the feeding direction FD. This enables the third scooping portion 224 and the fourth scooping portion 234 to scoop even a document that is long in the feeding direction onto the first supporting surface 221 and the second supporting surface 231. This configuration can further prevent the document that is long in the conveyance direction from getting caught on the first side regulating member 22 and the second side regulating member 23.

Subsequently, a second exemplary embodiment is described. The second exemplary embodiment is different from the first exemplary embodiment only in a configuration of the first side regulating member 22 and a configuration of the document stacking surface 211. Thus, since a configuration other than the document tray 2 in the second exemplary embodiment is similar to that in the first exemplary embodiment, a description thereof is omitted.

### Document Tray

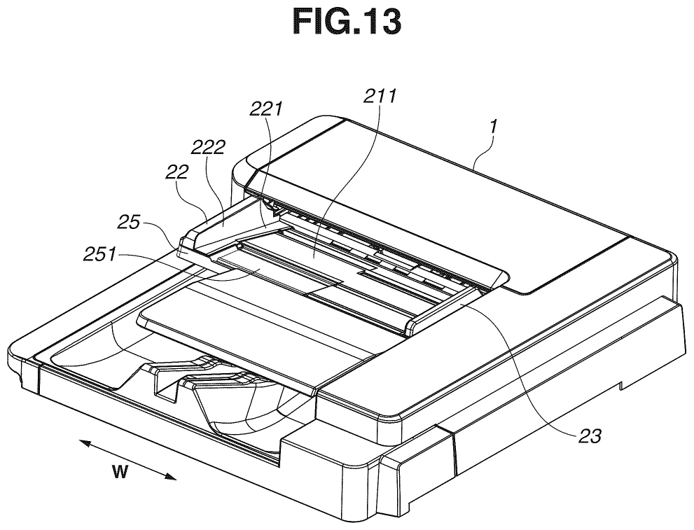

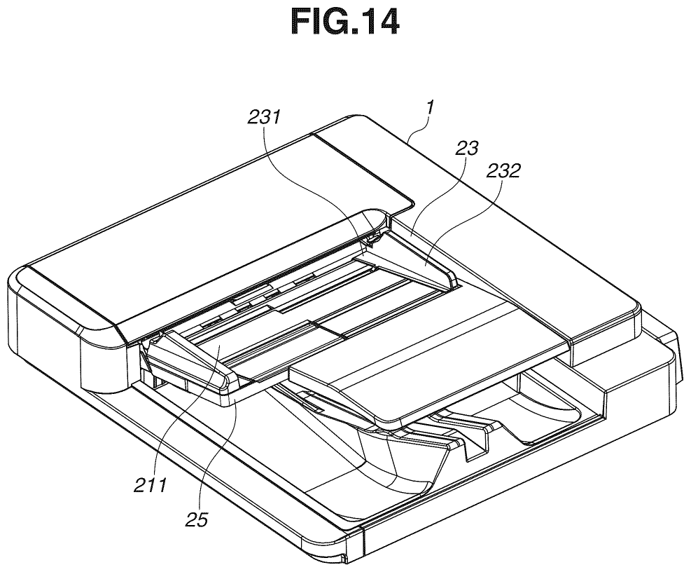

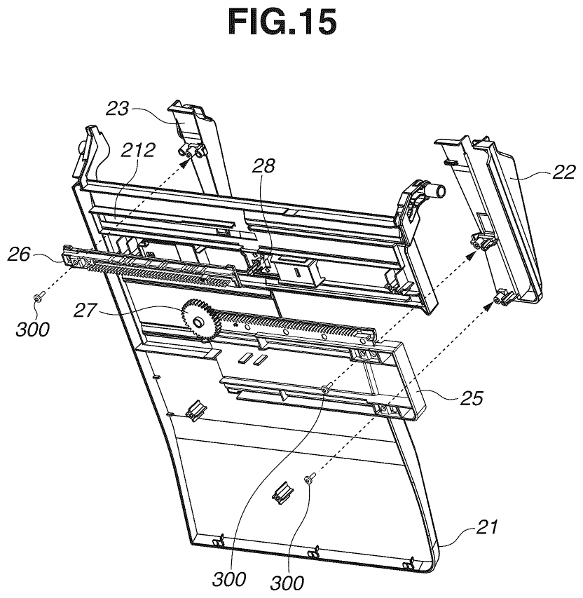

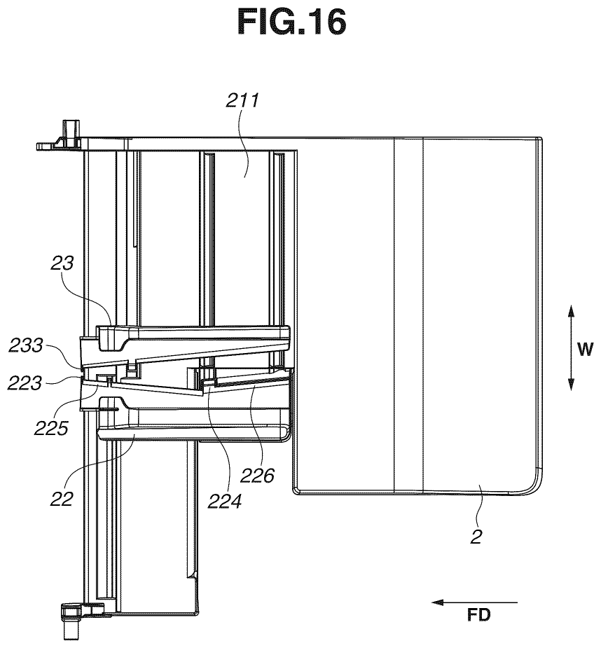

FIGS. 13 and 14 are perspective views of the ADF 1 according to the second exemplary embodiment. FIG. 15 is a perspective view of an upper cover member 21 in the document tray 2 according to the second exemplary embodiment when viewed from below. FIG. 16 is a top view of the document tray 2 according to the second exemplary embodiment. The document tray 2 includes the document stacking surface 211 for supporting the document, and the first side regulating member 22 and the second side regulating member 23 that regulate the respective positions of the document in the width direction W. The document tray 2 includes a movable stacking surface 251. The movable stacking surface 251 is a stacking surface that is movable in the width direction W integrally with the first side regulating member 22, and supports, together with the document stacking surface 211, the document when the first side regulating member 22 is located on the outside as illustrated in FIG. 13. As illustrated in FIG. 16, when the first side regulating member 22 moves inward, the movable stacking surface 251 retracts to enter under the document stacking surface 211. In other words, for a large size document, the movable stacking surface 251 is located at a supporting position at which the movable stacking surface 251, together with the document stacking surface 211, supports the document. For a small-sized document, the movable stacking surface 251 is located at a retracted position at which the movable stacking surface 251 is retracted below the document stacking surface 211. With this configuration, for a small-sized document, the movable stacking surface 251 is retracted and a space is formed above the discharge tray 3. This makes it easier for the user to visually recognize the small-sized document discharged to the discharge tray 3 and retrieve it.

As an interlocking mechanism for moving the first side regulating member 22 and the second side regulating member 23 in conjunction with each other, the upper cover member 21 includes the first rack portion 25, the second rack portion 26, and the pinion gear 27. An upper surface of the first rack portion 25 serves as the movable stacking surface 251, and is fixed to the first side regulating member 22 with screws 300. The second rack portion 26 is fixed to the second side regulating member 23 with a screw 300 via the slits 212, and the second side regulating member 23 and the second rack portion 26 are disposed to sandwich the upper cover member 21. The pinion gear supporting portion 28 is formed in the upper cover member 21, and the pinion gear 27 is rotatably engaged with the pinion gear supporting portion 28. The pinion gear 27 is provided to be engaged with the first rack portion 25 and the second rack portion 26. With this configuration, the rotation of the pinion gear 27 at the time of movement of one of the first side regulating member 22 or the second side regulating member 23 allows the other of the first side regulating member 22 and the second side regulating member 23 to move in the opposite direction in conjunction with the rotation.

### Document Scooping Shape

Subsequently, a document scooping shape according to the second exemplary embodiment is described. Since the configuration of the second supporting surface 231 is similar to that in the first exemplary embodiment, only the configuration of the first supporting surface 221 will be described below. Also in the second exemplary embodiment, the first supporting surface 221 of the first side regulating member 22 includes the first scooping portion 223 at the downstream side end of the first supporting surface 221 in the feeding direction FD and at the inner end of the first supporting surface 221 in the width direction W. The first scooping portion 223 is formed to extend to the lower side of the document stacking surface 211. The inside of the first supporting surface 221 in the width direction W serves as the first inclined portion 225 having a shape that approaches the first regulating surface 222 from the first scooping portion 223 as it extends upstream in the feeding direction FD. The first supporting surface 221 on the upstream side of the first inclined portion 225 serves as a third inclined portion 226 is shaped to extend away from the second regulating surface 232 toward the upstream side in the feeding direction FD. In other words, the inner side of the first supporting surface 221 in the width direction W has a V-shape when viewed from above. A boundary between the first inclined portion 225 and the third inclined portion 226 is located at a position that matches a boundary between the document stacking surface 211 and the movable stacking surface 251. The third scooping portion 224 is formed at a position at the downstream side end of the movable stacking surface 251 of the third inclined portion 226 (the boundary between the first inclined portion 225 and the third inclined portion 226).

The first scooping portion 223 is formed on the first supporting surface 221 of the first side regulating member 22 at the downstream side end of the first supporting surface 221 in the feeding direction FD also in the present exemplary embodiment. The second scooping portion 233 is formed on the second supporting surface 231 of the second side regulating member 23 at the downstream side end of the second supporting surface 231 in the feeding direction FD. This configuration can prevent the document from entering under the first supporting surface 221 and the second supporting surface 231 and being damaged.

In a case where the document tray 2 includes the movable stacking surface 251 that is movable in the width direction W, there is a possibility that the end of the document gets caught on the boundary between the document stacking surface 211 and the movable stacking surface 251 when the user sets the document. To address this, in the present exemplary embodiment, the third scooping portion 224 is formed at the downstream side end of the third inclined portion 226. This configuration can prevent a document from getting caught on the boundary between the document stacking surface 211 and the movable stacking surface 251 and being damaged while increasing visibility of a small-sized document and easiness to retrieve the small-sized document.

The above-mentioned characteristic configuration of the document tray 2 can be applied also to the manual feed tray 137e. Providing the first scooping portion 223 and the second scooping portion 233 described above in the pair of side regulating members provided in the manual feed tray 137e can prevent a recording medium from entering under the first supporting surface 221 and the second supporting surface 231 and being damaged.

In the above-mentioned first and second exemplary embodiments, both the first scooping portion 223 and the second scooping portion 233 are respectively disposed at the downstream side end of the first supporting surface 221 and the downstream side end of the second supporting surface 231. Alternatively, only the first scooping portion 223 may be disposed at the downstream side end of the first supporting surface 221, and the second scooping portion 233 may be disposed on the upstream side of the downstream side end of the second supporting surface 231. Only the first side regulating member 22 may be movable in the width direction, and the second side regulating member 23 may be fixed to be immovable with respect to the document tray 2.

According to the present disclosure, it is possible to prevent a small-sized sheet from entering under the side regulating member and being damaged when the side regulating member moves.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-022450, filed Feb. 16, 2024, which is hereby incorporated by reference herein in its entirety.

1. A sheet conveyance apparatus comprising:
a stacking tray having a sheet stacking surface on which a sheet is stacked;
a feeding roller configured to feed the sheet stacked on the stacking tray in a feeding direction; and
a first side regulating member disposed in the stacking tray to be movable in a width direction orthogonal to the feeding direction and configured to regulate a position of one end of the sheet stacked on the stacking tray in the width direction, the first side regulating member having a first regulating surface to be brought into contact with the one end of the sheet in the width direction, and a first supporting surface configured to, together with the sheet stacking surface, support the sheet,
wherein the first side regulating member has, at a downstream side end of the first supporting surface in the feeding direction, a first scooping portion that is configured to scoop the sheet onto the first supporting surface when the first side regulating member moves and that extends from the first supporting surface to below the sheet stacking surface.

2. The sheet conveyance apparatus according to claim 1, wherein an outer edge of the first supporting surface has a first inclined portion that is inclined with respect to the feeding direction so as to approach the first regulating surface as the first inclined portion extends upstream from the first scooping portion in the feeding direction.

3. The sheet conveyance apparatus according to claim 1, wherein the first scooping portion extends from the first supporting surface in the width direction, and is inclined downward as the first scooping portion extends away from the first regulating surface.

4. The sheet conveyance apparatus according to claim 1, further comprising an abutting portion configured to come into contact with a leading end of the sheet stacked on the stacking tray and regulate a movement of the sheet in the feeding direction,
wherein a distance from the abutting portion to the first scooping portion in the feeding direction is shorter than a length of a smallest-sized sheet that is conveyable by the sheet conveyance apparatus.

5. The sheet conveyance apparatus according to claim 1, further comprising an abutting portion configured to come into contact with a leading end of the sheet stacked on the stacking tray and regulate a movement of the sheet in the feeding direction,
wherein a distance from the abutting portion to the first scooping portion in the feeding direction is shorter than 91 millimeters (mm).

6. The sheet conveyance apparatus according to claim 1, further comprising a second side regulating member disposed in the stacking tray to be movable in the width direction and configured to regulate a position of another end of the sheet stacked on the stacking tray in the width direction, the second side regulating member having a second regulating surface to be brought into contact with the other end of the sheet in the width direction, and a second supporting surface configured to, together with the sheet stacking surface, support the sheet,
wherein the second side regulating member has, on a downstream side end of the second supporting surface in the feeding direction, a second scooping portion that is configured to scoop the sheet onto the second supporting surface when the second side regulating member moves and that extends from the second supporting surface to below the sheet stacking surface.

7. The sheet conveyance apparatus according to claim 6,
wherein an outer edge of the first supporting surface has a first inclined portion that is inclined with respect to the feeding direction so as to approach the first regulating surface as the first inclined portion extends upstream from the first scooping portion in the feeding direction, and
wherein an outer edge of the second supporting surface has a second inclined portion that is inclined with respect to the feeding direction so as to approach the second regulating surface as the second inclined portion extends upstream from the second scooping portion in the feeding direction.

8. The sheet conveyance apparatus according to claim 6,
wherein the first scooping portion extends from the first supporting surface in the width direction, and is inclined downward as the first supporting surface extends away from the first regulating surface, and
wherein the second scooping portion extends from the second supporting surface in the width direction, and is inclined downward as the second scooping portion extends away from the second regulating surface.

9. The sheet conveyance apparatus according to claim 6,
wherein the first supporting surface has, at a position upstream of the first scooping portion in the feeding direction, a third scooping portion extending below the sheet stacking surface, and
wherein the second supporting surface has, at a position upstream of the second scooping portion in the feeding direction, a fourth scooping portion extending below the sheet stacking surface.

10. The sheet conveyance apparatus according to claim 9, wherein the sheet stacking surface has a slit into which the third scooping portion and the fourth scooping portion are fitted so that the third scooping portion and the fourth scooping portion are slidable.

11. The sheet conveyance apparatus according to claim 6, further comprising an abutting portion that is configured to come into contact with a leading end of the sheet stacked on the stacking tray and regulate a movement of the sheet in the feeding direction,
wherein a distance from the abutting portion to each of the first scooping portion and the second scooping portion in the feeding direction is shorter than a length of a smallest-sized sheet that is conveyable by the sheet conveyance apparatus.

12. The sheet conveyance apparatus according to claim 6, further comprising an abutting portion that is configured to come into contact with a leading end of the sheet stacked on the stacking tray and regulate a movement of the sheet in the feeding direction,
wherein a distance from the abutting portion to each of the first scooping portion and the second scooping portion in the feeding direction is shorter than 91 mm.

13. The sheet conveyance apparatus according to claim 6, further comprising an interlocking mechanism configured to move the first side regulating member and the second side regulating member in conjunction with each other, the interlocking mechanism having a first rack portion in the first side regulating member, a second rack portion in the second side regulating member, and a gear configured to be engaged with the first rack portion and the second rack portion.

14. The sheet conveyance apparatus according to claim 1, further comprising a movable stacking surface configured to be movable in the width direction together with the first side regulating member, and be movable to a supporting position at which the movable stacking surface, together with the sheet stacking surface, supports the sheet and to a retracted position, below the lower side of the sheet stacking surface, at which the movable stacking surface is retracted.

15. The sheet conveyance apparatus according to claim 14, wherein the first supporting surface has, at a position at a downstream side end of the movable stacking surface in the feeding direction, a third scooping portion extending below the sheet stacking surface.

16. The sheet conveyance apparatus according to claim 1,
wherein the stacking tray is configured to be pivotable with respect to a main body of the sheet conveyance apparatus, and
wherein the first scooping portion is configured to slide to a downstream side end of the stacking tray in the feeding direction.

17. An image reading apparatus, comprising:
a stacking tray having a sheet stacking surface on which a sheet is stacked;
a feeding roller configured to feed the sheet stacked on the stacking tray in a feeding direction; and
a first side regulating member disposed in the stacking tray to be movable in a width direction orthogonal to the feeding direction and configured to regulate a position of one end of the sheet stacked on the stacking tray in the width direction, the first side regulating member having a first regulating surface to be brought into contact with the one end of the sheet in the width direction, and a first supporting surface configured to, together with the sheet stacking surface, support the sheet; and
an image reading unit configured to read an image of the sheet fed from the stacking tray,
wherein the first side regulating member has, at a downstream side end of the first supporting surface in the feeding direction, a first scooping portion that is configured to scoop the sheet onto the first supporting surface when the first side regulating member moves and that extends from the first supporting surface to below the sheet stacking surface.

18. An image forming apparatus, comprising:
a stacking tray having a sheet stacking surface on which a sheet is stacked;
a feeding roller configured to feed the sheet stacked on the stacking tray in a feeding direction; and
a first side regulating member disposed in the stacking tray to be movable in a width direction orthogonal to the feeding direction and configured to regulate a position of one end of the sheet stacked on the stacking tray in the width direction, the first side regulating member having a first regulating surface to be brought into contact with the one end of the sheet in the width direction, and a first supporting surface configured to, together with the sheet stacking surface, support the sheet; and
an image reading unit configured to read an image of the sheet fed from the stacking tray; and
an image forming unit configured to form an image on a recording medium based on the image of the sheet read by the image reading unit,
wherein the first side regulating member has, at a downstream side end of the first supporting surface in the feeding direction, a first scooping portion that is configured to scoop the sheet onto the first supporting surface when the first side regulating member moves and that extends from the first supporting surface to below the sheet stacking surface.
